(19) United States
(12) Patent Application Publication
(10) Pub. No.: US 2025/0031709 A1
(43) Pub. Date: Jan. 30, 2025

(54) SYSTEMS AND METHODS FOR AUTOMATIC SMOKERS

(71) Applicant: Mohamed Youssef, San Diego, CA (US)

(72) Inventor: Mohamed Youssef, San Diego, CA (US)

(21) Appl. No.: 18/360,697

(22) Filed: Jul. 27, 2023

(51) Int. Cl. A23B 4/052; A47J 37/07

(52) U.S. Cl. CPC A23B 4/0523; A47J 37/0704; A47J 37/0786

(57) ABSTRACT

Provided herein are systems and methods for offset smokers having a hardware subsystem having: a cooking chamber, a firebox disposed offset from the cooking chamber; a linear actuator system for opening and closing a firebox lid; a fuel dispenser disposed above the firebox configured to store a reserve of fuel; a variable speed blower fan at a top end of a chimney; and a plurality of data sensors; and a software subsystem configured to operate the hardware subsystem and to maintain a stable temperature within the cooking chamber during a cooking session, comprising: a flame flow engine configured to operate the variable speed blower fan and the linear actuator system; a fuel automation engine configured to trigger an addition of fuel from the fuel dispenser into the firebox; and an information aiding engine configured to receive data for updating a control logic.

### BACKGROUND OF INVENTION

### 1. Field of the Invention

The invention relates generally to smokers for cooking and grilling, and more particularly to automatic smokers.

### 2. Description of the Related Art

Offset smokers currently available for general use often present certain problems to users, such as, for example, inconsistent cooking results, difficulty in heat management, controlling the right amount of airflow in a given weather condition, inefficient fuel use, the need to continuously manage the fire for providing good smoke, and lack of expert guidance to the user. Therefore, there is a need for a solution to these problems.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Provided herein are offset smokers for cooking foods such as meat, having an intelligent system for control of airflow, fire management, and promoting constant heat during cooking, and optimization of fuel consumption at different weather conditions. The smokers provided herein can be referred to as a smoke auto pilot (SAP) system, or SAP. The SAP systems provided herein are machine learning or (Artificial Intelligence) AI-driven systems that optimize airflow control and heat management while promoting efficient use of fuel.

In some embodiments, the SAP systems provided herein include a cooking chamber, an offset firebox providing heat and smoke, a chimney, a fan, an actuator, and a motor. In some embodiments, the SAP systems provided herein are in communication with a server for collaborative dynamic learning and AI-driven functionality.

In some embodiments, the smokers provided herein are reverse-flow offset smokers. Reverse-flow offset smokers can provide a cooking process with even heat distribution, and easier temperature control.

The reverse-flow offset smokers provided herein can also provide better moisture retention to the cooking process by the baffle container or container in the cooking chamber. The baffle container can act as a heat sink, helping to maintain a more stable temperature and retain moisture within the cooking chamber. Further, this baffle container can help to reduce the risk of flare-ups, since the baffle container can act as a barrier between the food and the direct heat coming from the firebox, thus helping to prevent flare-ups and scorching, ensuring a more even cooking process. Therefore, this also helps to reduce the risk of burning food.

The SAP systems provided herein consist of two subsystems: the SAP-HW and the SAP-SW. The SAP subsystems can work together to monitor and control different aspects of the offset smokers provided herein for improved results when smoking foods.

Provided herein is an offset smoker system for cooking food, comprising: a hardware subsystem, comprising: a cooking chamber configured to house a cooking grate for holding the food, and a baffle container underneath the cooking grate; a firebox disposed offset from the cooking chamber and in communication with the cooking chamber via an opening, the firebox configured for housing a heat source, and having a firebox door on a side wall of the firebox, a lid on a top portion of the firebox, and air intake vents; a linear actuator system for opening and closing the firebox lid; a fuel dispenser disposed above the firebox configured to store a reserve of fuel; a motor connected to the fuel dispenser, wherein the motor is configured to cause a movement of at least a portion of the fuel dispenser; a chimney extending upwards from the cooking chamber; a variable speed blower fan at a top end of the chimney; and a plurality of temperature sensors, wherein a first temperature sensor is configured for measuring a cooking chamber temperature; a software subsystem configured to operate the hardware subsystem and to maintain a stable temperature within the cooking chamber during a cooking session, comprising: a control logic configured to receive user inputs; a flame flow engine configured to operate the variable speed blower fan, the air intake vents, and the linear actuator system such that the cooking chamber temperature measured by the first temperature sensor is within an allowable temperature range received from the user inputs; a fuel automation engine configured to trigger an addition of fuel from the fuel dispenser into the firebox under a predetermined condition, wherein the fuel automation engine sends a command to begin the addition of fuel to the hardware subsystem; and an information aiding engine configured to receive local weather data and use the local weather data to update the control logic; wherein operation of the variable speed blower fan causes negative pressure within the cooking chamber, causes air to be drawn from an exterior of the cooking chamber into the air intake vent, and causes air and smoke from the heat source to be drawn into the cooking chamber and directed around the food via the baffle container, and out of the chimney; wherein the command to begin the addition of fuel causes operation of the motor; and wherein the movement of the at least a portion of the fuel dispenser causes a predetermined portion of fuel from the reserve of fuel to be ejected from the fuel dispenser and into the firebox.

Provided herein is a method of automated cooking via an offset smoker system, the offset smoker system comprising: a hardware subsystem, comprising: a cooking chamber configured to house a cooking grate for holding the food, and a firebox disposed offset from the cooking chamber and in communication with the cooking chamber via an opening, the firebox configured for housing a heat source, and having a firebox door on a side wall of the firebox, a lid on a top portion of the firebox, and air intake vents; a linear actuator system for opening and closing the firebox lid; a fuel dispenser disposed above the firebox configured to store a reserve of fuel; a motor connected to the fuel dispenser, wherein the motor is configured to cause a movement of at least a portion of the fuel dispenser; a chimney extending upwards from the cooking chamber; a variable speed blower fan at a top end of the chimney; and a plurality of data sensors; a software subsystem configured to operate the hardware subsystem and to maintain a stable temperature within the cooking chamber during a cooking session, comprising: a control logic configured to receive user inputs; a flame flow engine configured to operate the variable speed blower fan and the linear actuator system such that data received from the plurality of data sensors is within an acceptable fluctuation threshold received from the user inputs; a fuel automation engine configured to trigger an addition of fuel from the fuel dispenser into the firebox under a predetermined condition, wherein the fuel automation engine sends a command to begin the addition of fuel to the hardware subsystem; and an information aiding engine configured to receive local weather data and use the local weather data to update the control logic; wherein operation of the variable speed blower fan causes negative pressure within the cooking chamber, causes air to be drawn from an exterior of the cooking chamber into the air intake vent, and causes air and smoke from the heat source to be drawn into the cooking chamber and directed around the food via the baffle container, and out of the chimney; the method comprising: retrieving the data from the plurality of data sensors; comparing the retrieved data to the acceptable fluctuation threshold; checking the flame flow engine to determine if additional fuel is needed if the retrieved data indicates that the retrieved data are below the acceptable fluctuation threshold; sending the command to the hardware subsystem to begin the addition of fuel to cause operation of the motor, if the determination is made that additional fuel is needed; moving the at least a portion of the fuel dispenser to push a predetermined portion of fuel from the reserve of fuel such that the predetermined portion of fuel is ejected from the fuel dispenser and into the firebox; delaying retrieval of data from the plurality of data sensors for a predetermined delay period; repeating the retrieving the data step and the comparing the retrieved sensor data step; and continuing to retrieve the data at predetermined time intervals.

Provided herein is a system for automated cooking via an offset smoker system, the offset smoker system comprising: a hardware subsystem, comprising: a cooking chamber configured to house a cooking grate for holding the food, and a firebox disposed offset from the cooking chamber and in communication with the cooking chamber via an opening, the firebox configured for housing a heat source, and having a firebox door on a side wall of the firebox, a lid on a top portion of the firebox, and air intake vents; a linear actuator system for opening and closing the firebox lid; a fuel dispenser disposed above the firebox configured to store a reserve of fuel; a motor connected to the fuel dispenser, wherein the motor is configured to cause a movement of at least a portion of the fuel dispenser; a chimney extending upwards from the cooking chamber; a variable speed blower fan at a top end of the chimney; and a plurality of data sensors; a software subsystem configured to operate the hardware subsystem and to maintain a stable temperature within the cooking chamber during a cooking session, comprising: a control logic configured to receive user inputs; a flame flow engine configured to operate the variable speed blower fan and the linear actuator system such that data received from the plurality of data sensors is within an acceptable fluctuation threshold received from the user inputs; a fuel automation engine configured to trigger an addition of fuel from the fuel dispenser into the firebox under a predetermined condition, wherein the fuel automation engine sends a command to begin the addition of fuel to the hardware subsystem; and an information aiding engine configured to receive local weather data and use the local weather data to update the control logic; wherein operation of the variable speed blower fan causes negative pressure within the cooking chamber, causes air to be drawn from an exterior of the cooking chamber into the air intake vent, and causes air and smoke from the heat source to be drawn into the cooking chamber and directed around the food via the baffle container, and out of the chimney; wherein the software subsystem is configured to monitor conditions by retrieving the data from the plurality of data sensors and comparing the retrieved data to the acceptable fluctuation threshold, and check the flame flow engine to determine if additional fuel is needed if the retrieved data indicates that the retrieved data are below the acceptable fluctuation threshold; wherein when the determination that additional fuel is needed is made, the software subsystem is configured to send the command to the hardware subsystem to begin the addition of fuel to cause operation of the motor; wherein the operation of the motor causes movement of the at least a portion of the fuel dispenser such that a predetermined portion of fuel from the reserve of fuel is pushed and ejected from the fuel dispenser and into the firebox.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1A is a schematic diagram showing a smoke auto pilot system, according to an aspect.

FIG. 1B is a chart showing a general overview of the hardware (HW) and software (SW) components of an exemplary smoke auto pilot (SAP) system, according to an aspect.

FIGS. 2A-2B depict a top view and isometric view, respectively, of the interior of the fuel dispenser and motor, according to an aspect.

FIG. 3 depicts a spritzing system of the SAP system, according to an aspect.

FIG. 4 depicts a side perspective view of an exemplary small scale SAP system, according to an aspect.

FIG. 5 depicts a top perspective view of an exemplary industrial/large-scale SAP system, according to an aspect.

FIG. 6 is a flow chart depicting an exemplary process for the operation of any of the SAP systems provided herein, according to an aspect.

FIG. 7 is a chart showing an exemplary list of functions of the flame flow engine (FFE), according to an aspect.

FIG. 8 is a chart showing an exemplary list of functions of the fuel automation engine (FAE), according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

As used herein and throughout this disclosure, the term “mobile device” refers to any electronic device capable of communicating across a data communication network. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver includes but is not limited to cellular, GPRS, Bluetooth, UWB, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a data communication network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, UMTS, 3G, 4G, Wi-Fi and BLUETOOTH networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server hosts or is in communication with a database having authentication information for users of a mobile network. A “user account” may include several attributes for a particular user, including a unique identifier of the mobile device(s) owned by the user, relationships with other users, call data records, bank account information, etc. A billing server may host a user account for the user to which value is added or removed based on the user's usage of services. One of these services includes mobile payment. In exemplary mobile payment systems, a user account hosted at a billing server is debited or credited based upon transactions performed by a user using their mobile device as a payment method.

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

Provided herein are smoke auto pilot (SAP) systems for cooking and smoking meat and other foods, having an offset smoker and artificial intelligence (AI) and machine learning systems for dynamic, adaptive monitoring and improvement of the smoking process.

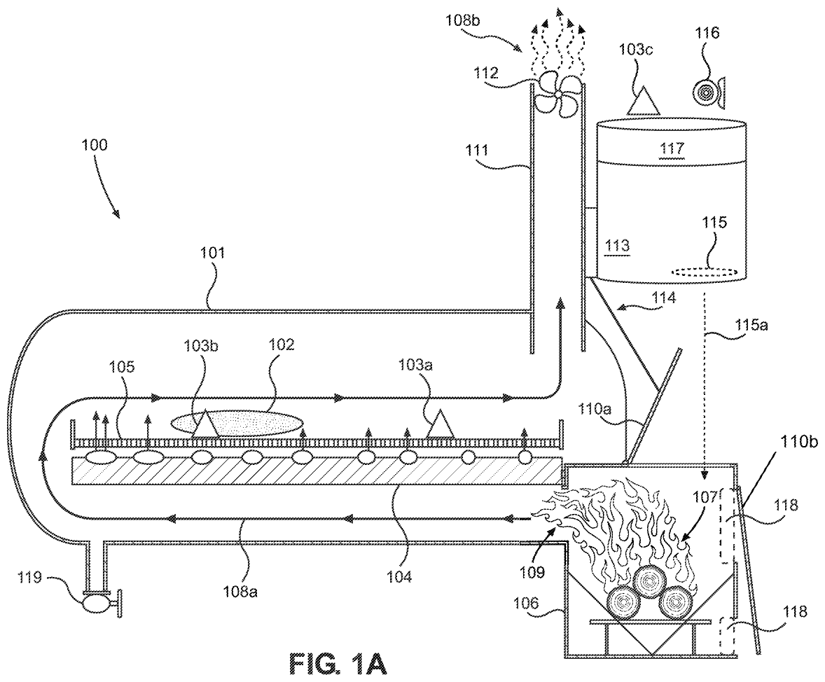

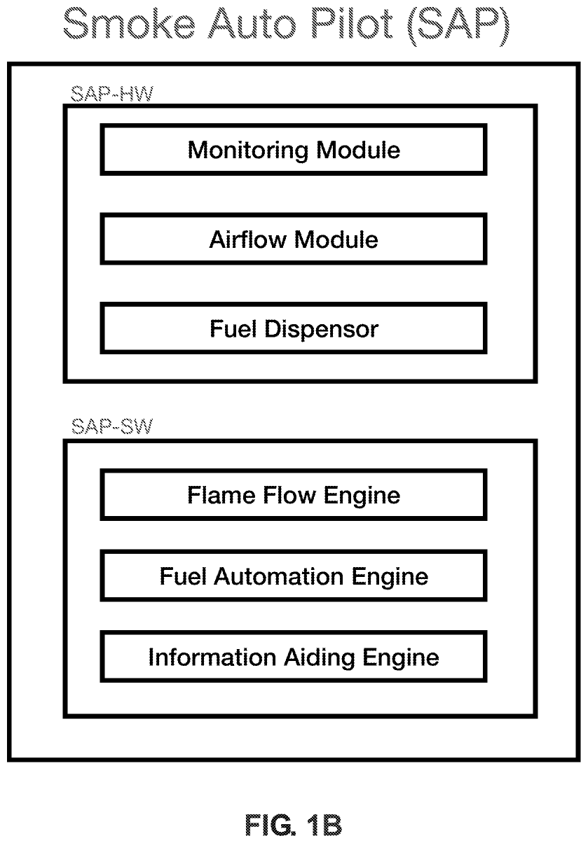

FIG. 1A is a schematic diagram showing a smoke auto pilot system 100 (also referred to herein as SAP, SAP system, smoker, or smoker system), according to an aspect. The smokers provided herein may include a cooking chamber 101, within which food 102 can be placed. Food 102 can be placed on a cooking grate 105. The cooking chamber 101 may be provided with one cooking grate or two cooking grates, or more. In some embodiments, the smokers provided herein include one main cooking grate. In some embodiments, the smokers provided herein include a first cooking grate (also referred to as a main cooking grate) and a second cooking grate (also referred to as an optional cooking grate). In such embodiments, the optional cooking grate is smaller than the main cooking grate, and is positioned over the area where the smoke meets the cooking grate and food at the end of the cooking chamber opposite to the firebox. Generally, the cooking grates are adjustable, and easily removed for cleaning, storage, and so on.

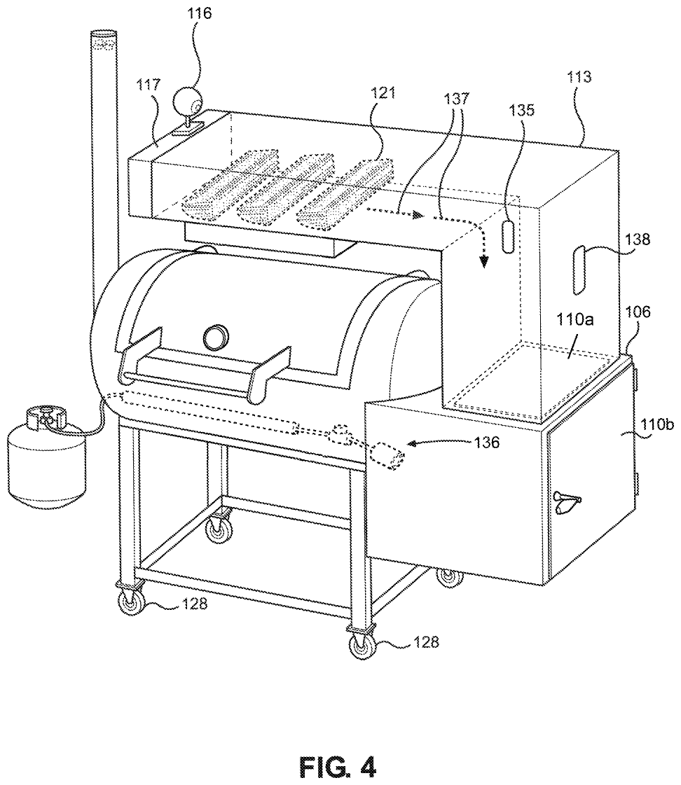

The cooking chamber 101 can also contain a plurality of temperature sensors, and a baffle container 104, which can be situated underneath the cooking grate 105. The temperature sensors may be a cooking chamber temperature sensor 103a, food temperature sensor 103b, and ambient temperature sensor 103c. The smokers may also be provided with a firebox 106, situated in an offset manner from the cooking chamber 101, within which a heat source 107 can be placed. The heat source can be a wood fire, or any combination of wood with other suitable heat sources, such as charcoal, or grilling pellets, for example. Generally, the heat source is a wood fire for creating smoke for the cooking process. The offset firebox 106 is provided with a firebox lid 110a on a top portion of the firebox, a firebox door 110b on a side wall of the firebox, and an automatic air intake system having air intake vents 118 such that hot air from the heat source is directed into the cooking chamber 101, through a connection point 109 (also referred to herein as an opening between the cooking chamber and the firebox) between the firebox and the cooking chamber. In some embodiments, this opening 109 is crescent-shaped. In some embodiments, the automatic air intake system also utilizes a solenoid for controlling air intake, a camera for providing visual cues on smoke levels, and computer vision tools for analyzing smoke levels. In some embodiments, the firebox door 110b opens vertically as shown as an example in FIG. 1A. In some embodiments, the firebox door 110b opens horizontally as shown as an example in FIG. 4.

In some embodiments, the firebox is provided with a firebox grate. The firebox grate allows for air circulation and ash removal. In some embodiments, the cooking chamber includes a grease drain 119 having a slight incline towards the center.

The baffle container 104 directs the hot air in a predetermined path, depicted by arrows 108. The air path 108a may lead over the food 102, and upwards out of a vertical chimney 111, indicated by arrows 108b, which provides an outlet for the air. The top of the chimney 111 may be provided with a fan 112.

The chimney 111 is provided on the same side of the reverse-flow offset smoker as the firebox 106, and is elevated slightly above the cooking grate 105, and may be tilted at approximately 5-15 degrees.

The fan 112 may be a variable speed blower fan, such that it can operate at different speeds necessary for creating negative pressure inside the cooking chamber. The negative pressure can then control the draw air and smoke into and near the food for the cooking and smoking process. The air can be drawn in through the air intake vents 118, into and through the cooking chamber along the pathway represented by arrows 108, and out of the vertical chimney 111.

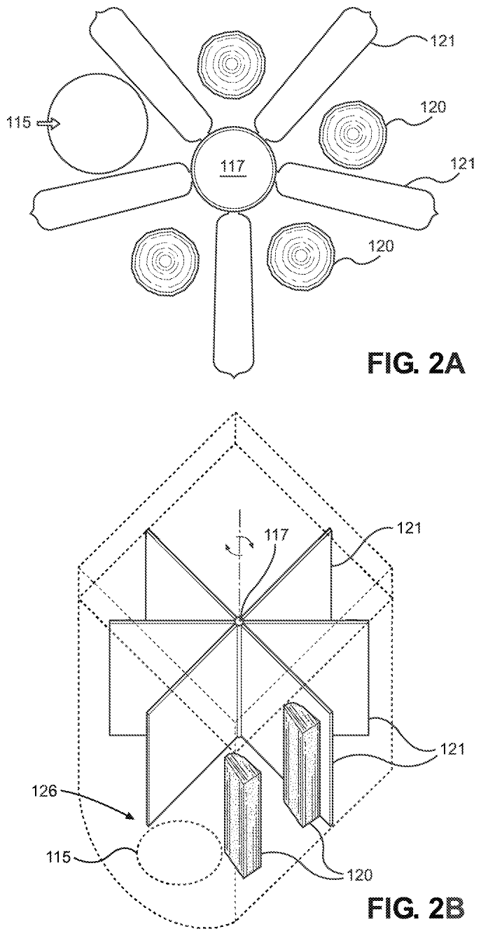

The smokers provided herein can also include a linear actuator system 114, which can control the firebox lid 110. The fuel dispenser 113 can also include a motor 117, and an open hole 115, through which fuel can be dispensed by falling down in the direction indicated by arrow 115a (discussed in further detail herein when referring to FIGS. 2A-2B). The SAP system can also be provided with a camera 116 to provide visual, monitoring of smoke level density, and amount of smoke. The camera 116 can be placed near or on the system in any suitable position, such as above the fuel dispenser 113.

In some embodiments, the smoker is provided with rotating caster wheels (shown by 128 in FIG. 4). The smokers provided herein can include any number of suitable wheels. The rotating caster wheels can be heavy-duty, 360 degree pivoting wheels with brake mechanisms to hold the smoker in place when needed.

In some embodiments, the smoke auto pilot systems provided herein include support systems. In some embodiments, the support systems are fixed, and are constructed from 5/16 thickness steel. In some embodiments, the support systems include handles on the exterior of the cooking chamber and firebox doors, constructed from heat-resistant materials for easy and safe opening and closing. In some embodiments, the support systems include door stoppers constructed from heat-resistant materials with a soft material, such as, for example, heat-resistant rubber. In some embodiments, the firebox door stopper is provided on a left side (also referred to herein as a first side, indicated by the placement of the firebox 106 in FIG. 1A), due to the firebox door hinges being provided on the left side, and the door opening towards the right side. In some embodiments, the cooking chamber door stopper is installed on a top side of the cooking chamber, and placed on a center portion of the door.

The components of the smokers provided herein can be constructed from any suitable material, such as, for example, heavy duty steel. Exemplary dimensions and construction materials are provided in Table 1 herein. As an example, the baffle container may be constructed from a different thickness of steel than the cooking chamber and firebox, while still providing good heat distribution and maintaining strength and durability. As another example, the thickness of the chimney may be constructed to match the thickness of the cooking chamber and firebox. In some embodiments, the support structure is constructed with heavy-duty steel tubing to provide a strong and stable foundation for the cooking chamber and firebox.

### Smoke Auto Pilot (SAP) Subsystems

FIG. 1B is a chart showing a general overview of the hardware (HW) and software (SW) components of an exemplary smoke auto pilot (SAP) system, according to an aspect. The HW components may include a monitoring module, an airflow module, and a fuel dispenser. The SW components may include a flame flow engine, a fuel automation engine, and an information aiding engine.

### Smoke Auto Pilot Hardware (SAP-HW) Subsystem

The smoke auto pilot hardware (SAP-HW) subsystem consists of the following modules, in addition to an emergency stop switch:

Temperature monitoring module: As discussed above when referring to FIG. 1 A, the systems are provided with a number of temperature sensors. In some embodiments, the smokers provided herein comprise three temperature sensors. As discussed herein when referring to FIG. 1A, the first is placed in the cooking chamber, the second is placed inside the food, and the third is placed outside of the smoker to measure ambient temperature. These are referred to as the cooking chamber temperature sensor, food temperature sensor, and ambient temperature sensor, respectively.

Blower fan: A variable-speed fan is provided at the top of the chimney, as shown in FIG. 1A.

Door lid opening mechanism: This module is used for opening and closing the firebox door. The firebox door is provided at the top of the firebox, and opens towards the direction of the smoker, as shown in FIG. 1A. This module has two functions: A) Fuel: the door is opened in order to add new fuel; and B) Airflow: the door is opened in order to control the intake of air by slightly or partially opening the lid. As an example, the door may be opened partially to control the amount of air intake into the cooking chamber. The linear actuator can be provided with instructions or script for opening the door a particular percentage of the fully open position, depending on how much air intake is needed. For example, the door could be instructed to open 10% of the fully open position if less air is needed, or 90% of the fully open position, if more air is needed, and so on.

Fuel dispenser: The system functions as a dispenser of wood log splits, charcoal, wood pellets, or any other such suitable fuel elements, wherein the motor rotates the steel rod and connected dividers, pushing the wood splits around the circular base, as shown and discussed when referring to FIGS. 2A-2B. As discussed above, when the hole in the base aligns with a wood split, the wood split will drop through the hole onto the firebox.

Detection system: The main function of this module is to confirm that the fuel has been added, and to monitor the fuel level. The monitoring of fuel can help the system to determine the optimal time to add more fuel, and the adaptive nature of this system can help to avoid running out of fuel during cooking.

### Smoke Auto Pilot Software (SAP-SW) Subsystem

The goal of the smoke auto pilot software (SAP-SW) subsystem is to maintain a stable temperature within the cooking chamber, and to optimize fuel consumption during a cooking session. The SAP-SW subsystem consists of the following modules:

Flame Flow Engine (FFE): The FFE is an intelligent control logic to minimize the difference between the desired temperature and the actual temperature within the cooking chamber. This system controls the blower fan, firebox lid door opening (frequency and width of opening), and monitors the need for more fuel. In some embodiments, a “fluctuation_percentile” value is provided in the “user_inputs.json” file to create an allowable temperature range to keep the cooking chamber temperature within this permissible range. When the fan speeds alone or fan speed in conjunction with the linear actuator (if allowed to be open per the “user_inputs” file) do not allow for meeting the allowable temperature range, the system may determine that adding fuel may be a solution. In some embodiments, the allowable temperature range includes a desired cooking temperature of approximately 175° F., a desired cooking chamber temperature of approximately 170° F., and a desired fluctuation of approximately 10% from said desired temperatures.

The system also learns the typical pattern of temperature drop and rise rates. The system is able to use the readings from the ambient temperature sensor and cooking chamber temperature sensor to learn the cooking chamber temperature drop and rise rates, and can use this data to improve its predictions of when more fuel will need to be added in order to maintain the best or desired stable temperature inside the cooking chamber. The FFE also updates the control logic to incorporate predictions from the model. This will help the system to anticipate the effect that adding fuel or adjusting the airflow has on the cooking chamber temperature. This can help to enable more proactive and precise control over the cooking process.

In some embodiments, the system can record temperature readings from the ambient and cooking chamber temperature sensors at regular intervals, such as, for example, every minute. In some embodiments, the system can calculate the temperature drop rate as the difference between consecutive cooking chamber temperature readings divided by the time interval. In some embodiments, the ambient temperature drop rate can be calculated in a similar manner.

In some embodiments, when new fuel is added, the system can record the cooking chamber temperature, the time when fuel is added, and then monitor the rise in temperature following the addition of fuel. The temperature can then be monitored continuously.

In some embodiments, the observed temperature drop rate, ambient temperature change rate, and temperature rise rate data are used to build a model that predicts the cooking chamber temperature based on current conditions and the amount of added fuel. This can be achieved using techniques such as linear regression, reinforcement learning, or any suitable advanced machine learning algorithms.

In some embodiments, the control logic can be updated to incorporate predictions derived from models such as the model discussed above. As was also discussed above, this can help the system to anticipate the effect that adding fuel, or adjusting the airflow may have on the cooking chamber.

In some embodiments, each time the cooking chamber temperature drops below the “fluctuation_percentile” as defined in a “user_inputs” file, the data can be recorded and the incidents recorded using a counter, such as “fluctuation_deviations” stored in the “user outputs” file.

Fuel Automation Engine (FAE): This system can provide a timer, or threshold, or combination of both, to trigger fuel addition under certain conditions. For example, if any of the speeds of the blower fan alone cannot maintain the desired cooking chamber temperature, or if the fan in combination with the linear actuator opening the firebox door cannot maintain the desired cooking chamber temperature, the system can be triggered to add fuel. If under such conditions the cooking chamber temperature still below the allowable temperature range as inputted by the user or received as a prewritten script, the logic can be set to allow adding new fuel. As an example, the script for the logic can be provided as inputting a desired cooking chamber temperature as “cooking_chamber_temperature” and the allowable temperature range as “allowable_temperature_range.” If “cooking_chamber_temperature” is below “allowable_temperature range,” then “fuel_addition_required” is set to “True.” This logic can then trigger the SAP-HW procedure for adding more fuel.

Generally, the above can enable the SAP-SW and SAP-HW subsystems to work in conjunction for monitoring and controlling fuel levels. In addition to the logic for triggering the SAP-HW procedure for adding more fuel as discussed above, the SAP-HW uses information stored in a user inputs file to translate the user desired fuel container increments to reflect the size of wood splits used during this cooking. For example, this can be ⅓ full, ⅔ full, or full. These can be translated into actual step motor steps that can be communicated with the step motor driver.

The system can also be provided with a fuel addition delay, to account for the time it takes for the newly added fuel to start producing heat, such that more fuel than necessary is not added while the cooking chamber temperature can come up to the desired cooking chamber temperature.

Information Aiding Engine (IAE): This system can integrate weather data into the control system. This system can periodically fetch weather data periodically, such as, for example, every 10 minutes during a cooking process. This data can then be used to update the control logic to account for temperature, wind speed, humidity, and so on, and adjust the variable speed fan speed, adjust the linear actuator opening percentage, and fuel consumption accordingly.

This system may monitor significant changes in local weather forecasts, and keep track of weather data over time in order to identify any substantial changes in wind speed, humidity, temperature, and the like. If a significant change is detected, the control logic can be adjusted to compensate for the new weather conditions, ensuring that the cooking chamber temperature remains stable.

FIGS. 2A-2B depict a top view and isometric view, respectively, of the interior of the fuel dispenser 113 and motor 117, according to an aspect. FIG. 2A depicts an interior view of the fuel dispenser as shown in FIG. 1A, and FIG. 2B depicts a cutaway view showing the interior of the fuel dispenser.

In some embodiments, the fuel dispenser is provided as a steel container, for holding wood log splits 120. In some embodiments, the container has a capacity for holding 3-16 wood log splits, wherein each piece measures approximately 3-4 inches by 3-4 inches by 8-12 inches. The fuel dispenser may include a steel rod 125 at the center, from which a plurality of steel dividers 121 extend towards the outer circumference of the dispenser. As an example, each steel divider 121 can be approximately 5/18-inch steel.

The steel rod 125 may be situated on a circular base, in the region indicated generally by 126. As an example, the circular base may have a radius of approximately 8.2 inches, with a hole 115 having a radius of approximately 5 inches towards its edge. The steel rod 125 may be attached to a motor 117 that enables the steel rod to rotate around its center, on the circular base, thereby causing the steel dividers 121 to push the wood splits around the base. The motor 117 may be provided in any suitable size, such as in the examples shown in FIGS. 2A-2B. The hole 115 enables wood splits pushed over it to fall through the circular base. Then, the wood split falling through the hole 115 will fall onto the firebox below the dispenser, thereby refueling the fire in the firebox.

The dispenser can also be loaded through a hinged side panel (not shown). In some embodiments, the side panel can be secured by a latch or locking mechanism.

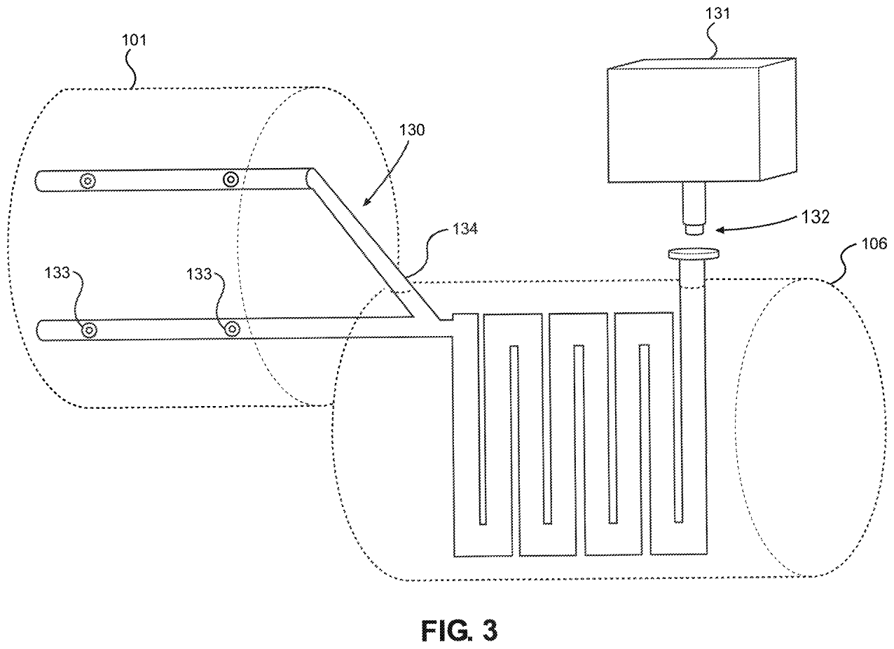

FIG. 3 depicts a spritzing system 130 of the SAP system, according to an aspect. Any of the smokers provided herein may include a spritzing system, also referred to herein as a sprinkler system, for automated spraying inside the cooking chamber 101. Spraying meat with a predetermined liquid mixture can be useful for the cooking process. Any suitable mixture can be used, such as, for example, a mixture of water and apple cider vinegar in a predetermined ratio. This can provide the meat with moisture and desired flavor, since smoking meat can be a long and slow process that can dry out the meat if care is not taken to provide additional moisture during the cook time. Thus, spraying the meat with a liquid can help to keep the surface moisture and prevent it from drying out, and result in a more succulent end product. The user's choice of liquid mixture can also provide the meat with a particular flavor. As an example, apple cider vinegar can impart a sweet, tangy flavor to the meat that can complement the flavors of the smoked meat. Flavors such as apple cider vinegar can add a subtle layer of complexity to the overall flavor profile of the cooked meat. Addition of ingredients containing sugar, such as apple cider vinegar, can also help form the “bark” on the smoked meat, which is a dark, flavorful crust that forms on the surface of the meat during smoking. Many barbecue enthusiasts highly praise this bark. Spritzing the meat with heated or steamed liquid during the cooking process can also help with temperature regulation. The act of spritzing can help maintaining the cooking temperature and smoke level of the cooking chamber, thereby slowing down the cooking process and allowing the smoke to penetrate more deeply into the food.

The spritzing system 130 may include a spritzing mixture container 131 for housing the liquid to be applied to the food, a control valve 132, a plurality of sprinklers 133, and a connector hose 134 allowing the mixture container 131 and the control valve 132 to be in fluid communication. The control valve 132 may be of any suitable type, such as, for example, a dial, or any other rotatable element, for example. In some embodiments, the spritzing system can pass through the firebox 106 such that the liquid to be sprayed onto the food is heated/steamed. Generally, this can help to minimize the need to open the cooking chamber which could cause the temperature of the cooking chamber to go down. Passing the spritzing system through the firebox can therefore help to maintain a consistent internal cooking chamber temperature.

FIG. 4 depicts a side perspective view of an exemplary small scale SAP system, according to an aspect. Small scale smoke systems can be used for smaller scale productions, home use, and so on. The small scale SAP system can include a cooking chamber 101, a motor 117, a camera 116, a solenoid 135 for flipping wood splits on/off, a fuel addition/fuel level detection sensor 138, an ignition and torch system 136, a firebox 106, and firebox lid 110a and firebox door 110b. In some embodiments, a fuel dispenser 113 is oriented above the main body of the smoker, and the motor 117 is configured to cause a portion of the fuel dispenser to move, such as an internal shelf or other similar element, which can then push and direct wood splits 121 in a predetermined direction as indicated by arrows 137. The wood splits 121 can then fall downwards into an opened firebox 106 as shown by arrows 137.

Placing the wood log splits in a lattice structure can be beneficial. To do this, a solenoid 135, for example, may be used to rotate one of the wood splits before falling into the firebox to ensure that it will be perpendicular to the previous one when it falls into the firebox. This will promote better airflow underneath the fire bed and generate good smoke.

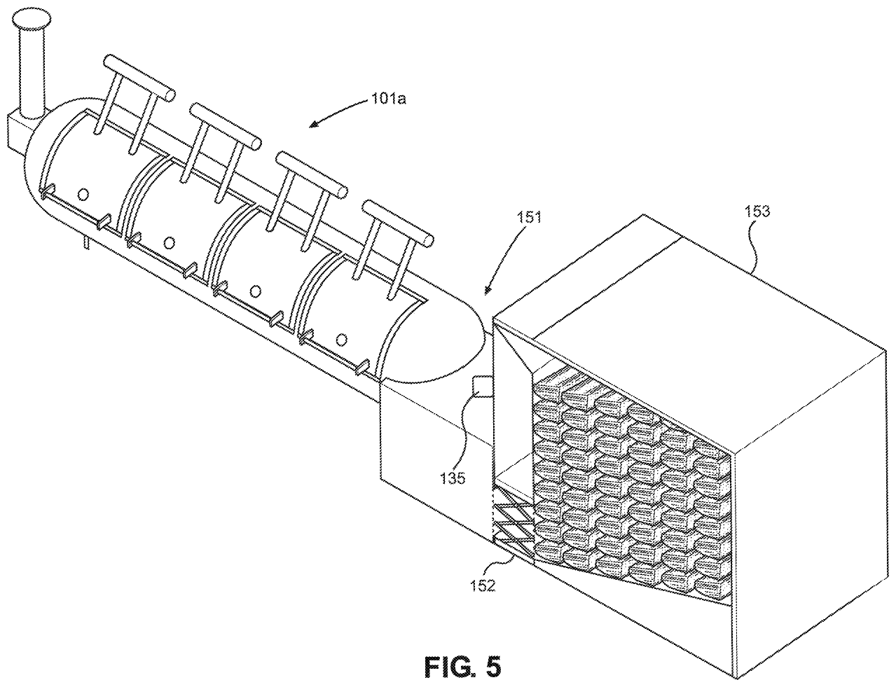

FIG. 5 depicts a top perspective view of an exemplary industrial/large-scale SAP system, according to an aspect. Large-scale or industrial SAP systems may be used for commercial purposes, for example. The industrial system can include a multi-part cooking chamber or a plurality of cooking chambers 101a, a barbecue wood split dispenser system 151, a solenoid 135 to flip the wood splits on/off, a wood splitting mechanical lift system 152, and a barbecue wood split storage container 153.

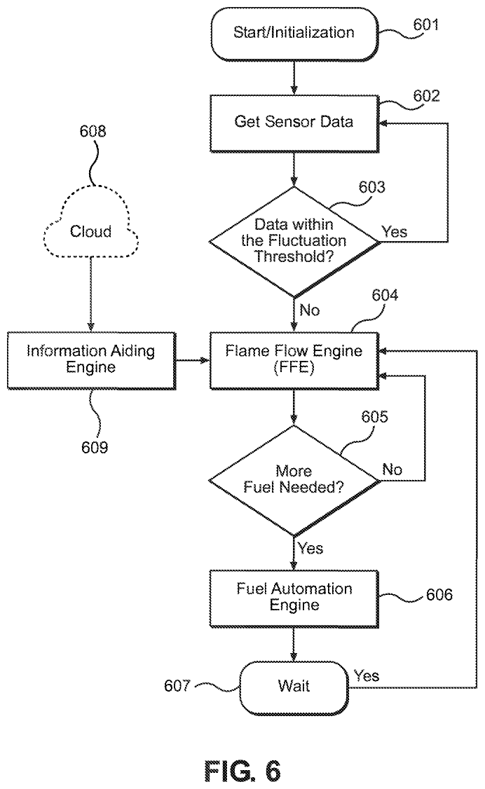

FIG. 6 is a flow chart depicting an exemplary process for the operation of any of the SAP systems provided herein, according to an aspect. Upon starting/initialization of the system (step 601), the system retrieves sensor data (step 602), such as, for example, temperature data received from the plurality of temperature sensors of the offset smoker system. The system next checks to see if the retrieved data is within the acceptable fluctuation threshold (step 603). At step 603 when checking if the sensor data is within the acceptable fluctuation threshold, if “yes,” the system returns to step 602 in order to continue monitoring the system. At step 603, if “no,” the system checks the flame flow engine (FFE) (step 604) and checks if more fuel is needed (step 605). The FFE controls the variable speed blower-fan, firebox lid, and intake vents as described before. The objective of the FFE is to keep the fire management and airflow within the fluctuation thresholds. If “yes,” the system proceeds to check the fuel automation engine (step 606). The indication that more fuel is needed will then refill the fuel, and system will wait (step 607) for this process to complete. Next, the system will check again with the flame flow engine (step 604) to see if more fuel is needed (step 605). If “no,” the system will continue to monitor sensor data, and FFE and FAE will engage to maintain the fluctuation within the desired levels.

In conjunction with the above steps, information stored in the cloud (step 608) will be downloaded for use with the information-aiding engine (step 609). Data received from the cloud can be used for the flame flow engine and the fuel automation engine to optimize the cooking process, for example. A server for storing data, model parameters, local weather predictions, and information relating to the functions performed by the SAP system can be accessed by the computer system of the SAP system. In one aspect of the invention, deep learning, Short-Term and Long-Term Learning model parameters, or reinforcement learning model can be run on the server, while each user can refine the last layer of the model based on the local information on their local device, the edge device, and make a personalized prediction based on of this particular cook and user profile.

In some embodiments, the linear actuator system 114 is used for opening and closing the firebox door. Generally, the linear actuator has three functions:
1. Once the logic of adding fuel is triggered “True,” the linear actuator needs to engage to a predefined value stored in a centralized location, e.g., a file such as an “Operational_Control” file to open the firebox. In some embodiments, the linear actuator can retract or extend in order to open or close the firebox door.
2. Once the Step Motor stop motion (discussed in further detail under point 3 below) is performed, the linear actuator needs to extend to a predetermined value stored in a centralized location, e.g., the “Operational_Control” file.
3. “user_inputs” should contain “True” and “False” options for using the linear actuator as an intake air vent to improve the airflow. When this logic is set to “True” in the “user_inputs” file, the linear actuator can be used to maintain a desirable airflow and constant heat throughout the cooking process. For these reasons, in some embodiments, there may be constraints imposed on how far the linear actuator opens the door. In some embodiments, a constrained threshold percentage value is used, e.g., 15% of the span between the retract value and extended values (as discussed above). These percentages can be stored in a centralized location, e.g., the “Operational_Control” file.

In some embodiments, a toggle switch allows user input to manually override automated control over the linear actuator extend and retract functions. In some embodiments, a safety feature is provided wherein manual user intervention can override any automated control over the linear actuator module.

In some embodiments, the step motor rotates the cylindrical fuel dispenser, as shown and described when referring to FIGS. 2A-2B. The step motor can rotate the cylindrical container using ⅓, ⅔, or one full unit using the motors' driver. The container size may be predefined, and measured at approximately 193 cubic inches, for example. The number of containers generally is predefined and stored in a centralized location within the code used for programming the smokers provided herein, e.g., the “Operational_Control” file.

In some embodiments, an IR beam sensor is provided. The beam sensor's primary function is to confirm that fuel has been added and to monitor the fuel level. This can help the smoke auto pilot system determine the optimal time to add fuel, and be adaptive to avoid running out of fuel during cooking. The fuel tank size at the beginning of the cooking process generally is incorporated within the “user input” data file, while the current inventory of fuel generally is stored in the “user_outputs” file.

In some embodiments, the smoke auto pilot systems are provided with an emergency button to shut off power for all components of the system.

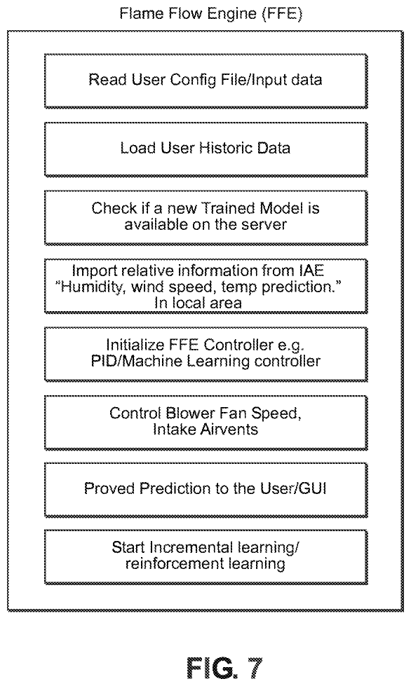

FIG. 7 is a chart showing an exemplary list of functions of the flame flow engine (FFE), according to an aspect. The flame flow engine can perform functions including, but not limited to, reading user configuration files and input data, loading user historical data, checking if a new or updated trained model or retrained model is available on the server, importing relative information from the information aiding engine (IAE) such as humidity, wind speed, temperature, and temperature predictions for the local area, initializing the FFE controller (e.g., proportional-integral-derivative (PID)/machine learning controller/deep reinforcement learning model), controlling the blower fan speed and the intake air vents, providing predictions to the user/GUI, and starting incremental learning/reinforcement learning based on uses of the smoke auto pilot system.

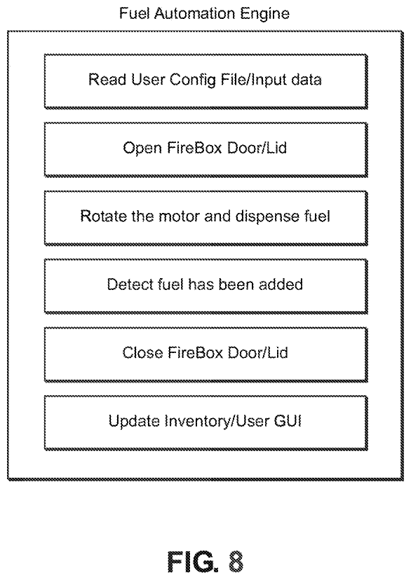

FIG. 8 is a chart showing an exemplary list of functions of the fuel automation engine (FAE), according to an aspect. The FAE can perform functions including, but not limited to, reading user configuration files and input data, opening the firebox door, rotating the motor and dispensing fuel, detecting that fuel has been added, closing the firebox door, and updating the inventor/user GUI.

In some embodiments, a camera is strategically positioned to capture detailed video footage of smoke exiting the chimney or smoke stack. The video data is processed to extract individual frames that serve as the basis for further analysis. The data can be processed locally or partially locally and then sent to the cloud for further processing. Optical flow techniques, for example, the Lucas-Kanade method, are applied to the frames to estimate the motion of smoke particles between consecutive frames. This method provides a 2D vector field outlining the movement of smoke at each pixel. The optical flow information is used to calculate the magnitude and direction of the smoke flow, providing a measure of the draft—the speed and direction of the smoke exiting the chimney. The average magnitude of the optical flow vectors across each frame represents the average speed of the smoke particles. Additional parameters, such as local ambient wind speed and temperature, can be incorporated into the analysis to achieve a more accurate measure of the draft. These parameters significantly influence the smoke's behavior, with wind speed affecting the smoke's dispersion rate and direction and ambient temperature affecting the smoke's buoyancy. A correction model can be used to calibrate the average magnitude of the optical flow vectors to account for these effects.

### EXAMPLES

### Example 1

Plain text may be used to input instructions for any of the smokers provided herein. As an example, plain text in .json file format can be used. An example of an input file is as follows:

```
{
  “heat_control”: {
    “desired_cooking_temperature”: 275,
    “fluctuation_percentile”: 10,
    “food_ready_temperature”: 165
  },
  “smokiness_scale”: {
    “comment”: “1: low smoke, 2: medium smoke, 3: high smoke”,
  “desired_smoke_level”: 1
  },
  “menu”: {
    “meat_type”: “Beef”,
    “meat_cut”: “Ribeye”
  }
}
```

An example of an output file is as follows:

```
user_outputs[“expected_cook_time”] = 0
  user_outputs[“confidence_level”] = 0
  user_outputs[“remaining_wood_slot_counts”] = 0
  user_outputs[“supply_risk_indicator”] = 0
  user_outputs[“temperature_graphs”] = {
    “cooking_chamber_sensor”: [ ],
    “food_sensor”: [ ],
    “ambient_temperature”: [ ]
  }
  user_outputs[“fluctuation_deviations”] = 0
  user_outputs[“cook_number”] = 0
  user_outputs[“hours”] = 0
  save_user_outputs(user_outputs)
```

### Example 2

The reverse-flow offset smokers provided herein may be constructed with the following exemplary dimensions listed in Table 1.

TABLE 1

| Feature | | Specification |
|---|---|---|
| Cooking | Length | 48 inches (1,219.2 m) |
| chamber | Diameter | 24 inches (609.6 mm) |
| | Circumference | 75.4 inches (1,914.76 mm) |
| | Thickness | ¼-inch thick steel |
| Firebox | Length | 24 inches (609.6 mm) |
| | Diameter | 18 inches (457.2 mm) |
| | Circumference | 56.5 inches (1,435.7 mm) |
| | Thickness | ¼-inch thick steel |
| Opening between | Alignment gap | 2-3 inches (50-75 mm) |
| cooking chamber | Opening height | 4 inches (101.6 mm) |
| and firebox | Opening span | 80% of the firebox's circumference |
| | | (45.2 inches or 1,148.56 mm) |
| | Opening position | 2 inches (50.8 mm) below the top of |
| | | the firebox and 4 inches (101.6 mm) |
| | | above the bottom of the cooking |
| | | chamber |
| Baffle | Baffle container | Approximately 44 inches |
| container | bottom length | (1,117.6 mm) |
| | Baffle container | Approximately 22 inches |
| | bottom width | (558.8 mm) |
| | Baffle container | 0.6 inches (15.24 mm) |
| | bottom depth | |
| | Baffle container | 0.5 in, 0.75 in, 1 in, 1.25 in, 1.5 in, |
| | hole sizes | 1.75 in, 2 in (12.7 mm, 19.05 mm, |
| | | 25.4 mm, 31.75 mm, 38.1 mm, |
| | | 44.45 mm, 50.8 mm) |
| | Thickness | 5/16-inch (4.76 mm) thick steel |
| Cooking grates | Grate 1 position height | 4-6 inches (101.6-152.4 mm) above |
| | within chamber | the baffle container |
| | Grate 2 width | 8-10 inches (203.2-254 mm) |
| | Grate 2 length | 22 inches (558.8 mm) |
| | Grate 2 position height | 2-3 inches (50.8-76.2 mm) above the |
| | within chamber | main cooking grate (grate 1) |
| | Firebox grate height | 3-4 inches (76.2-101.6 mm) above |
| | | the firebox bottom |
| | Grease drain | Slight incline towards the center, |
| | | with a valve and bucket |
| | Thickness | ⅛ inch thick steel |
| Chimney | Height | 12 inches (304.8 mm) |
| | Diameter | 4 inches (101.6 mm) |
| | Thickness | 5/16-inch thick steel pipe |
| Doors/lids | Cooking chamber door width | 75-80% of the cooking chamber's |
| | | circumference |
| | Cooking chamber door height | 80% of the chamber's diameter |
| | Firebox door width | 70-80% of the firebox's diameter |
| | Firebox door height | 70-80% of the firebox's diameter |
| Support structure | Construction material | Heavy-duty steel tubing |
| Rotating caster | Construction material | Heavy-duty steel tubing |
| wheels | | |

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. An offset smoker system for cooking food, comprising:
a hardware subsystem, comprising:
a cooking chamber configured to house a cooking grate for holding the food, and a baffle container underneath the cooking grate;
a firebox disposed offset from the cooking chamber and in communication with the cooking chamber via an opening, the firebox configured for housing a heat source, and having a firebox door on a side wall of the firebox, a lid on a top portion of the firebox, and air intake vents;
a linear actuator system for opening and closing the firebox lid;
a fuel dispenser disposed above the firebox configured to store a reserve of fuel;
a motor connected to the fuel dispenser, wherein the motor is configured to cause a movement of at least a portion of the fuel dispenser;
a chimney extending upwards from the cooking chamber;
a variable speed blower fan at a top end of the chimney; and
a plurality of temperature sensors, wherein a first temperature sensor is configured for measuring a cooking chamber temperature;
a software subsystem configured to operate the hardware subsystem and to maintain a stable temperature within the cooking chamber during a cooking session, comprising:
a control logic configured to receive user inputs;
a flame flow engine configured to operate the variable speed blower fan, the air intake vents, and the linear actuator system such that the cooking chamber temperature measured by the first temperature sensor is within an allowable temperature range received from the user inputs;
a fuel automation engine configured to trigger an addition of fuel from the fuel dispenser into the firebox under a predetermined condition, wherein the fuel automation engine sends a command to begin the addition of fuel to the hardware subsystem; and
an information aiding engine configured to receive local weather data and use the local weather data to update the control logic;
wherein operation of the variable speed blower fan causes negative pressure within the cooking chamber, causes air to be drawn from an exterior of the cooking chamber into the air intake vent, and causes air and smoke from the heat source to be drawn into the cooking chamber and directed around the food via the baffle container, and out of the chimney;
wherein the command to begin the addition of fuel causes operation of the motor; and
wherein the movement of the at least a portion of the fuel dispenser causes a predetermined portion of fuel from the reserve of fuel to be ejected from the fuel dispenser and into the firebox.

2. The offset smoker system of claim 1, wherein the predetermined condition for the addition of fuel is a timer, such that passage of a predetermined length of time causes the trigger for the addition of fuel.

3. The offset smoker system of claim 1, wherein the predetermined condition for the addition of fuel is a determination by the flame flow engine that operation of the variable speed blower fan and the linear actuator system results in the cooking chamber temperature measured by the first temperature sensor being below the allowable temperature range.

4. The offset smoker system of claim 1, comprising a detection system configured to monitor a level of fuel in the firebox, and confirm addition of the predetermined portion of fuel into the firebox when the command to begin the addition of fuel is issued.

5. The offset smoker system of claim 1, wherein the cooking chamber has a first end and a second end, and the firebox, the chimney, and the fuel dispenser each are disposed at the first end of the cooking chamber.

6. The offset smoker system of claim 1, where the movement of the at least a portion of the fuel dispenser is rotation of the fuel dispenser.

7. The offset smoker system of claim 1, wherein the fuel dispenser comprises an inner housing having a base, a hole within the base, and a plurality of dividers each extending from a center of the inner housing towards an outer circumference of the dispenser, and wherein fuel is housed in spaces between each divider of the plurality of dividers.

8. The offset smoker system of claim 1, further comprising a camera in communication with the software subsystem, wherein the camera is configured to monitor smoke levels from the offset smoker system.

9. The offset smoker system of claim 1, wherein the reserve of fuel comprises a plurality of wood splits, and the system comprising a solenoid configured to turn the wood splits; such that a first wood split is dispensed into the firebox, and a second wood split is dispensed into the firebox perpendicular to the first wood split; and such that dispensing of each wood split from the plurality of wood splits allows for perpendicular stacking of the wood splits in the firebox.

10. A method of automated cooking via an offset smoker system, the offset smoker system comprising:
a hardware subsystem, comprising:
a cooking chamber configured to house a cooking grate for holding the food, and a firebox disposed offset from the cooking chamber and in communication with the cooking chamber via an opening, the firebox configured for housing a heat source, and having a firebox door on a side wall of the firebox, a lid on a top portion of the firebox, and air intake vents;
a linear actuator system for opening and closing the firebox lid;
a fuel dispenser disposed above the firebox configured to store a reserve of fuel;
a motor connected to the fuel dispenser, wherein the motor is configured to cause a movement of at least a portion of the fuel dispenser;
a chimney extending upwards from the cooking chamber;
a variable speed blower fan at a top end of the chimney; and
a plurality of data sensors;
a software subsystem configured to operate the hardware subsystem and to maintain a stable temperature within the cooking chamber during a cooking session, comprising:
a control logic configured to receive user inputs;
a flame flow engine configured to operate the variable speed blower fan and the linear actuator system such that data received from the plurality of data sensors is within an acceptable fluctuation threshold received from the user inputs;
a fuel automation engine configured to trigger an addition of fuel from the fuel dispenser into the firebox under a predetermined condition, wherein the fuel automation engine sends a command to begin the addition of fuel to the hardware subsystem; and
an information aiding engine configured to receive local weather data and use the local weather data to update the control logic;
wherein operation of the variable speed blower fan causes negative pressure within the cooking chamber, causes air to be drawn from an exterior of the cooking chamber into the air intake vent, and causes air and smoke from the heat source to be drawn into the cooking chamber and directed around the food via the baffle container, and out of the chimney;
the method comprising:
retrieving the data from the plurality of data sensors;
comparing the retrieved data to the acceptable fluctuation threshold;
checking the flame flow engine to determine if additional fuel is needed if the retrieved data indicates that the retrieved data are below the acceptable fluctuation threshold;
sending the command to the hardware subsystem to begin the addition of fuel to cause operation of the motor, if the determination is made that additional fuel is needed;
moving the at least a portion of the fuel dispenser to push a predetermined portion of fuel from the reserve of fuel such that the predetermined portion of fuel is ejected from the fuel dispenser and into the firebox;
delaying retrieval of data from the plurality of data sensors for a predetermined delay period;
repeating the retrieving the data step and the comparing the retrieved sensor data step; and
continuing to retrieve the data at predetermined time intervals.

11. The method of claim 10, wherein the plurality of data sensors comprises temperature sensors, wherein a first temperature sensor is configured for measuring a cooking chamber temperature sensor data is temperature data; and wherein the acceptable fluctuation threshold is an allowable temperature range.

12. The method of claim 10, wherein the plurality of data sensors comprises a camera.

13. The method of claim 10, wherein the fuel dispenser comprises an inner housing having a base, a hole within the base, and a plurality of dividers each extending from a center of the inner housing towards an outer circumference of the dispenser, and wherein fuel is housed in spaces between each divider of the plurality of dividers.

14. The method of claim 10, wherein the checking the flame flow engine step comprises sending a command to the linear actuator system to carry out at least one of the functions selected from: opening the firebox door, turning on the variable speed blower fan, and adjusting a speed of the variable speed blower fan.

15. A system for automated cooking via an offset smoker system, the offset smoker system comprising:
a hardware subsystem, comprising:
a cooking chamber configured to house a cooking grate for holding the food, and a firebox disposed offset from the cooking chamber and in communication with the cooking chamber via an opening, the firebox configured for housing a heat source, and having a firebox door on a side wall of the firebox, a lid on a top portion of the firebox, and air intake vents;
a linear actuator system for opening and closing the firebox lid;
a fuel dispenser disposed above the firebox configured to store a reserve of fuel;
a motor connected to the fuel dispenser, wherein the motor is configured to cause a movement of at least a portion of the fuel dispenser;
a chimney extending upwards from the cooking chamber;
a variable speed blower fan at a top end of the chimney; and
a plurality of data sensors;
a software subsystem configured to operate the hardware subsystem and to maintain a stable temperature within the cooking chamber during a cooking session, comprising:
a control logic configured to receive user inputs;
a flame flow engine configured to operate the variable speed blower fan and the linear actuator system such that data received from the plurality of data sensors is within an acceptable fluctuation threshold received from the user inputs;
a fuel automation engine configured to trigger an addition of fuel from the fuel dispenser into the firebox under a predetermined condition, wherein the fuel automation engine sends a command to begin the addition of fuel to the hardware subsystem; and
an information aiding engine configured to receive local weather data and use the local weather data to update the control logic;
wherein operation of the variable speed blower fan causes negative pressure within the cooking chamber, causes air to be drawn from an exterior of the cooking chamber into the air intake vent, and causes air and smoke from the heat source to be drawn into the cooking chamber and directed around the food via the baffle container, and out of the chimney;
wherein the software subsystem is configured to monitor conditions by retrieving the data from the plurality of data sensors and comparing the retrieved data to the acceptable fluctuation threshold, and check the flame flow engine to determine if additional fuel is needed if the retrieved data indicates that the retrieved data are below the acceptable fluctuation threshold;
wherein when the determination that additional fuel is needed is made, the software subsystem is configured to send the command to the hardware subsystem to begin the addition of fuel to cause operation of the motor;
wherein the operation of the motor causes movement of the at least a portion of the fuel dispenser such that a predetermined portion of fuel from the reserve of fuel is pushed and ejected from the fuel dispenser and into the firebox.

16. The system of claim 15, wherein the plurality of data sensors comprises temperature sensors, wherein a first temperature sensor is configured for measuring a cooking chamber temperature sensor data is temperature data; and wherein the acceptable fluctuation threshold is an allowable temperature range.

17. The system of claim 15, wherein checking the flame flow engine comprises sending a command to the linear actuator system to carry out at least one of the functions selected from: opening the firebox door, turning on the variable speed blower fan, and adjusting a speed of the variable speed blower fan.

18. The system of claim 15, wherein the fuel dispenser comprises an inner housing having a base, a hole within the base, and a plurality of dividers each extending from a center of the inner housing towards an outer circumference of the dispenser, and wherein fuel is housed in spaces between each divider of the plurality of dividers.

19. The system of claim 15, wherein the movement of the at least a portion of the fuel dispenser is rotation of the fuel dispenser, and the rotation causes the plurality of dividers to push the predetermined portion of fuel towards the hole such that the predetermined portion of fuel is ejected out of the hole and into the firebox.

20. The system of claim 15, wherein the reserve of fuel comprises a plurality of wood splits, and the system comprising a solenoid configured to turn the wood splits; such that a first wood split is dispensed into the firebox, and a second wood split is dispensed into the firebox perpendicular to the first wood split; and such that dispensing of each wood split from the plurality of wood splits allows for perpendicular stacking of the wood splits in the firebox.
